(19) United States
(12) Patent Application Publication
(10) Pub. No.: US 2023/0245513 A1
(43) Pub. Date: Aug. 3, 2023

(54) DEADBOLT WITH PANIC CODE AND POWER SAVING FUNCTIONALITY

(71) Applicant: Lewis Hyman, Inc., Carson, CA (US)

(72) Inventor: Robert LeBlanc, Kennesaw, GA (US)

(21) Appl. No.: 18/103,844

(22) Filed: Jan. 31, 2023

Related U.S. Application Data
(60) Provisional application No. 63/304,793, filed on Jan. 31, 2022.

(51) Int. Cl. G07C 9/00; E05B 47/00; E05B 65/10

(52) U.S. Cl. CPC G07C 9/00571; E05B 47/0012; E05B 65/1086; E05B 2047/0065; G07C 2009/00388; G07C 2009/00825

(57) ABSTRACT

An electronic door lock includes an electromechanical locking mechanism, computer hardware configured for selectively moving the electromechanical locking mechanism between a locked configuration and an unlocked configuration, and one or more networking components that are configured for facilitating communication between the computer hardware and one or more computer networks that are external to the electronic door lock. The electronic door lock maybe configured for receiving an access code from a user, analyzing the access code to determine whether the access code is a first particular code or a second particular code, in response to determining that the access code is the first particular code, causing the electromechanical locking mechanism to disengage a lock component configured to prevent a door from opening, and in response to determining that the access code is the second particular code, initiating a transmission of an emergency signal via the one or more networking components.

### CROSS-REFERENCE TO RELATED APPLICATIONS

This application claims priority to U.S. Provisional Pat. Application Serial No. 63/304,793, filed Jan. 31, 2022, entitled, “DEADBOLT WITH PANIC CODE AND POWER SAVING FUNCTIONALITY,” the disclosure of which is hereby incorporated by reference in its entirety.

### BACKGROUND

Electronic door locks are a feature of many residences and often provide an electromechanical mechanism configured to engage and disengage a door lock. Homeowners may choose electronic door locks to enable residents and visitors to open a door without a key, for instance, by entering a code on a keypad. This may be advantageous as a backup for when a resident loses a key, for rental homes, or to grant temporary access to housekeepers and workers. Electronic door locks may provide similar benefits for businesses and vacation rentals, for example.

One issue with electronic door locks, and even traditional door locks, is that it can take some time for an individual to do whatever is necessary to unlock the lock. For example, it may take the individual a number of seconds to set down whatever they may be holding, enter the access code into the door lock, and select an unlock button, which then unlocks the door. During that time, in rare circumstances, it’s possible that the individual entering the access code may be accosted by an individual who wishes to enter the home (e.g., to burglarize the home). For example, when the individual is entering the access code, a burglar may confront the individual with a weapon and force the individual enter the access code. The burglar may then enter and burglarize the home, and potentially injure the individual in the process. Accordingly, there is currently a need for locks with improved safety features to protect individuals as they enter their home.

Further, electronic door locks may also incorporate network connectivity. Ordinarily, electronic door locks use a single power source (e.g., batteries) to power an unlocking mechanism and a network interface device. However, the network interface device may consume battery power continuously to maintain a connection. As a result, the batteries may drain, and the electronic door lock may become electronically inoperable and lose connectivity. This may result in the electronic door lock being unreliable for emergency situations.

Accordingly, there is a need for electronic door locks with improved safety features, and with improved features for maintaining battery life and ensuring electronic lock functionality, such as when an entrant is under duress.

### SUMMARY

It should be appreciated that this Summary is provided to introduce a selection of concepts in a simplified form that are further described below in the Detailed Description. This Summary is not intended to be used to limit the scope of the claimed subject matter.

According to one aspect of the disclosure, an electronic door lock includes: (1) an electromechanical locking mechanism; (2) computer hardware that is configured for selectively moving the electromechanical locking mechanism between a locked configuration and an unlocked configuration; and (3) one or more networking components that are configured for facilitating communication between the computer hardware and one or more computer networks that are external to the electronic door lock. In certain embodiments, the electronic door lock is configured for (1) receiving an access code from a user; (2) analyzing the access code to determine whether the access code is a first particular code or a second particular code; (3) in response to determining that the access code is the first particular code, causing the electromechanical locking mechanism to disengage a lock component configured to prevent a door from opening; and (4) in response to determining that the access code is the second particular code, initiating a transmission of an emergency signal via the one or more networking components.

In various embodiments, a method of generating an electronic emergency alert includes: (1) receiving a panic code at a door lock that is on a particular door at a particular residence; (2) in response to receiving the panic code, automatically generating an electronic emergency alert. The electronic emergency alert may include: (A) an indication that that there is an emergency at a particular location; and (B) an indication that the particular location is the particular door at the particular residence. The method may also include facilitating the transmission of the alert to at least one designated individual.

According to an additional aspect of the disclosure, an electronic door lock includes: (1) an electromechanical locking mechanism; (2) computer hardware that is configured for selectively moving the electromechanical locking mechanism between a locked configuration and an unlocked configuration; and (3) one or more networking components that are configured for facilitating communication between the computer hardware and one or more computer networks that are external to the electronic door lock. The electronic door lock may be configured to allow a user to selectively toggle the door lock between: (A) a first configuration, in which the electronic door lock is connected to a local communications network; and (B) a second configuration, in which the electronic door lock is not connected to local communications network.

### BRIEF DESCRIPTION OF THE DRAWINGS

Various embodiments of the invention will be described below. In the course of the description, reference will be made to the accompanying drawings, which are not necessarily drawn to scale, and wherein:

FIG. 1A is a perspective view of an exterior assembly of an electronic door lock according to various embodiments of the present disclosure.

FIG. 1B is a perspective view of an interior assembly of an electronic door lock of FIG. 1A.

FIG. 1C is a cutaway view of an interior assembly of an electronic door lock of FIG. 1A.

FIG. 1D is an exploded view an electronic door lock of FIG. 1A.

FIG. 2 is a diagram illustrating an exemplary network environment in which the present systems and methods may operate according to various embodiments of the present disclosure.

FIG. 3 is a diagram illustrating an exemplary physical environment in which the present systems and methods may operate according to various embodiments of the present disclosure.

FIG. 4 is a schematic diagram of an electronic door lock computer according to various embodiments of the present disclosure.

FIG. 5 is a flowchart showing an example process for unlocking an electronic lock according to various embodiments of the present disclosure.

FIG. 6 is an example graphical user interface for setting emergency contacts according to various embodiments of the present disclosure.

FIG. 7 is an example graphical user interface for displaying an alert message according to various embodiments of the present disclosure.

FIG. 8 is a flowchart showing an example process for configuring connectivity settings according to various embodiments of the present disclosure.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. References to an element in the plural may include embodiments with one element. Likewise, references to an element in the singular may include embodiments having multiple elements.

For the purposes of this disclosure, the term “electronic door lock” is used to describe a door lock that is disengaged by an electromechanical locking mechanism, such as a motor or solenoid. The electronic door lock may be installed on an exterior or interior door, and may engage and disengage a lock component that is configured to prevent a door from opening. For instance, the lock component may be a deadbolt, and the electronic door lock may cause the deadbolt to extend into a door frame to secure the door in a closed and locked position. In some embodiments, the lock component may be a pin that prevents a knob or handle from rotating.

Additionally, the electronic door lock may include a keyless activation device which activates the electromechanical locking mechanism to unlock or lock the deadbolt. For example, the electronic door lock may include a keypad, and a user may gain entry to a house by entering a particular code into the keypad. The electronic door lock may also allow a user to enter a different particular code which causes an emergency signal to be sent, and may, in various embodiments, also unlock the door to avoid alerting an aggressor. The electronic door lock may also have a manual control, such as a thumb turn, and permit a user to lock and unlock the door without action by the electromechanical locking mechanism.

Further, the electronic door lock may also have a network interface device configured to interact with a wide area network (WAN) and/or a local area network (LAN). In various embodiments, the network interface device may receive a signal via the WAN and/or the LAN, and, in response to the signal, cause the lock control mechanism to lock and/or unlock.

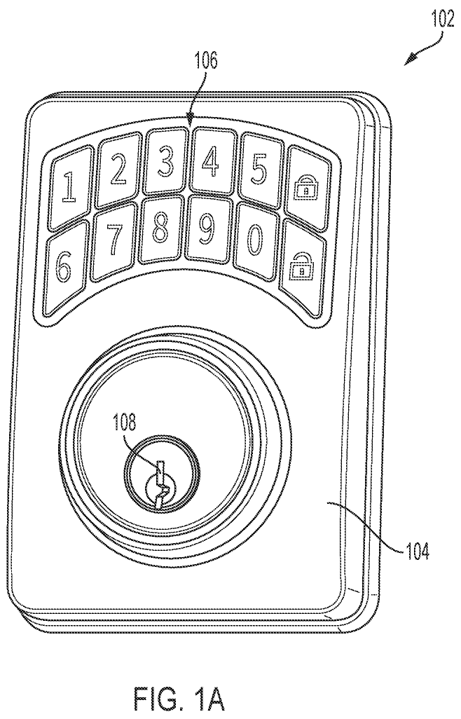

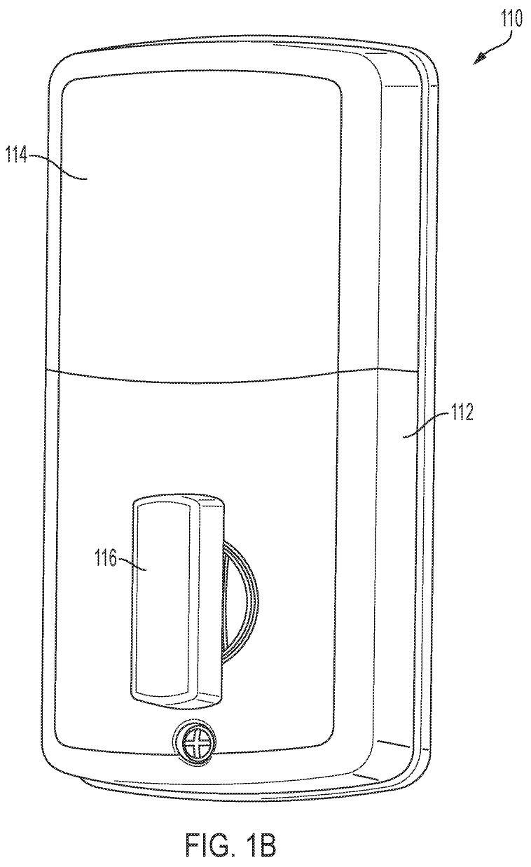

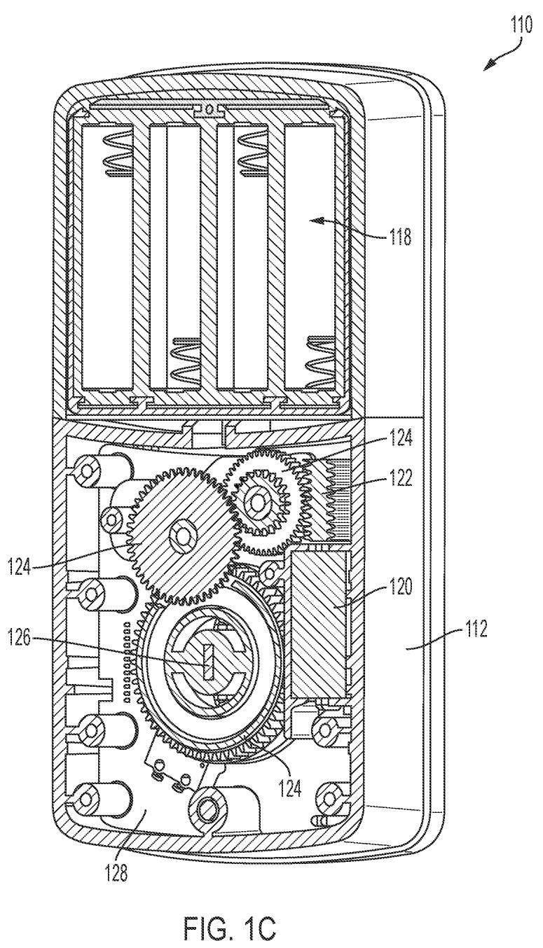

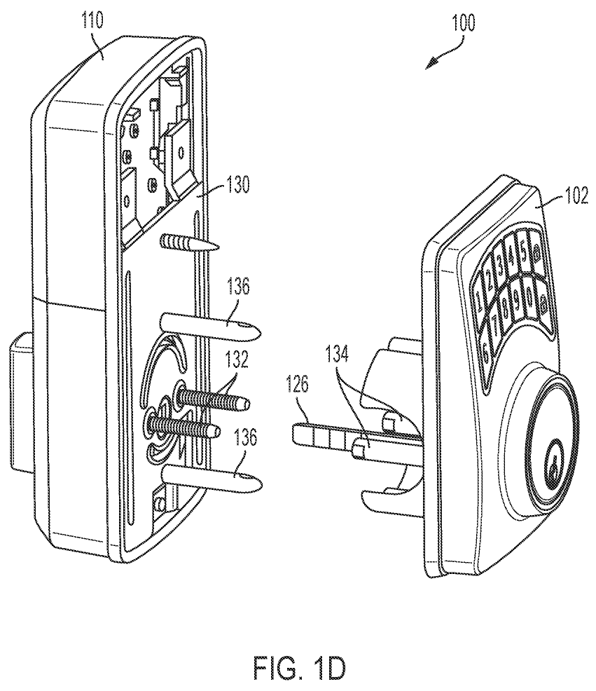

FIG. 1A illustrates a perspective view of an exterior assembly 102 of an electronic door lock 100 according to various embodiments of the present disclosure. The exterior assembly 102 may be attached to an exterior side of a door (e.g., opening to the outside, opening to a hallway, etc.). The exterior assembly 102 may include a front housing 104 made of a suitable, and in some cases weatherproof, material (e.g., metal, plastic, etc.). The front housing 104 may protect a circuit board (not shown) operatively connected to, and configured to receive signals from, a keypad 106. The keypad 106 may include a plurality of buttons which may be numbered, lettered, or have other identifying symbols, such as lock and unlock buttons. When a user selects the buttons of the keypad 106 in a correct order (e.g., enters a correct access code), the circuit board may send a signal that triggers an electromechanical locking mechanism, as described below, to unlock or lock a door, such as a door physically associated with the locking mechanism (e.g., by retracting or extending a dead bolt associated with the door). The buttons of the keypad 106 may be components of a single membrane, such as an elastomeric keypad which may, for example, be made from silicone rubber or other suitable material. Further, the front housing 104 may also secure a gasket (e.g., a suitable flexible material such as silicon or rubber) against a door surface to prevent water intrusion and damage to the circuit board.

The exterior assembly 102 may also include a keyhole 108. The front housing 104 may protect a lock tumbler disposed between the front housing 104 and a door. This may provide redundant entry options, for instance if batteries of the electronic door lock have insufficient charge to power the keypad 106 and/or the electromechanical locking mechanism.

FIG. 1B illustrates a perspective view of the interior assembly 110 of the electronic door lock of FIG. 1A. The interior assembly 110 may be disposed on an interior of a door relative to the exterior assembly 102 (e.g., the inside of a home, a room, etc.). The interior assembly 110 may include a rear housing 112 and a battery cover 114. In certain embodiments, the interior assembly 110 may include circuitry and electronically communicate with the exterior assembly, for instance via a wire running through the door. The interior assembly 110 may also house computer hardware, including a network interface device. Further, the rear housing 112 may protect an electromechanical locking mechanism including, e.g., a motor and linkages (e.g., gears) configured to retract and extend a dead bolt or other lock component. The electromechanical locking mechanism may also or alternatively include a solenoid, servo, or any other suitable mechanism.

The battery cover 114 may be detachably coupled with the rear housing 112 and obscure a battery compartment (e.g., the battery cover 114 may slide or snap off of the rear housing 112). The rear housing 112 and/or the battery cover 114 may hide fasteners (e.g., screws, bolts) that secure the interior assembly 110 to a door. The interior assembly 110 may also include a thumb turn 116 (or other suitable manual lock control mechanism) configured to retract or extend a dead bolt (or other suitable locking mechanism) when a user rotates the thumb turn 116 in an appropriate direction. In certain embodiments, the thumb turn 116 may manually operate the electromechanical locking mechanism. For example, in various embodiments, rotating the thumb turn 116 counterclockwise may cause the deadbolt to extend into a “door locked” orientation, and rotating the thumb turn 116 clockwise may cause the deadbolt to retract into a “door unlocked” orientation.

FIG. 1C is a cutaway view of an interior assembly of the electronic door lock of FIG. 1A. The cutaway view of FIG. 1C illustrates a battery compartment 118. For example, the electronic door lock 100 may be powered by batteries of any suitable standard size (e.g., AA, AAA, C, D, etc.). FIG. 1C further illustrates components of the electromechanical locking mechanism of the electronic door lock 100. For example, an electromechanical locking mechanism according to various embodiments may include a motor 120. The motor 120 may, in certain embodiments, be connected to a plurality of gears, including a worm gear 122 and spur gears 124. The gears may cooperate to rotate a turnpiece 126 configured to engage with a deadbolt to selectively extend and retract the deadbolt in a door frame, for instance. Other electromechanical locking mechanisms are also envisioned, such as solenoids, direct drive motors, linear actuators, servos, etc.

The motor 120 may receive power and/or control signals from a circuit board 128 housed in the interior assembly 110. The circuit board 128 may include computer hardware that is configured for selectively moving the electromechanical locking mechanism between a locked configuration and an unlocked configuration. For example, the circuit board 128 may include or be connected to at least one sensor to determine a position of a dead bolt as part of a feedback to ensure the motor 120 does not continue operating after the deadbolt is fully extended or retracted, thereby avoiding damage to the electromechanical locking mechanism. The at least one sensor may include a force sensor, a Hall sensor, a conductivity sensor, or any other suitable sensor that can detect the position of a deadbolt and allow the circuit board 128 to identify a locked configuration and an unlocked configuration of a deadbolt or other lock component.

Further, the circuit board 128 may include one or more networking components that are configured for facilitating communication between the computer hardware and one or more computer networks that are external to the electronic door lock. For example, the circuit board 128 may include a network interface device configured to receive commands via a LAN and/or a WAN (e.g., WiFi, LoRa, Bluetooth, the Internet, cell networks, etc.), and provide control signals directly or indirectly to the motor 120. Components of the circuit board 128 may also receive signals from the keypad 106 and provide control signals to the motor 120 based on keypad entries.

FIG. 1D is an exploded view an electronic door lock 100 according to various embodiments of the present disclosure. As illustrated in FIG. 1D, the exterior assembly 102 and the interior assembly 110 of the electronic door lock 100 may cooperate to selectively secure to a door in a locked configuration and to operate a dead bolt or other locking mechanism as described above. For example, the interior assembly 110 may include a plate 130 holding fasteners 132 (e.g., screws or bolts) that secure in bosses 134 of the exterior assembly 102. In this way, the fasteners 132 may be secured from an interior of a dwelling such that the fasteners 132 cannot be removed from the exterior. Additionally, the interior assembly 110 may include pins 136 extending toward the exterior assembly 102. The pins 136 may engage with detents in a flange or other receivers of the exterior assembly 102, and counteract torque applied to the exterior assembly due to rotation of a key in keyhole 108. Further, the turnpiece 126 may extend from the exterior assembly 102 (i.e., from a lock tumbler).

The turnpiece 126 may protrude into a receiver on the electromechanical locking mechanism within interior assembly 110 and attach to a thumb turn 116. The turnpiece 126 may also extend through a receiver on a dead bolt configured to extend or retract the dead bolt in response to the turnpiece 126 rotating. Thus, in certain embodiments, when a key is turned in the keyhole 108, the turn piece 126 may cause a dead bolt to extend or retract based on the direction in which the key is turned. The turn piece 126 may also rotate the thumb turn 116 and manually operate the electromechanical locking mechanism. Alternatively, the electromechanical locking mechanism may disengage from the turnpiece 126 between activation signals (e.g., from the keypad or from the network interface device). Further, in some embodiments, the electromechanical locking mechanism may cause a rotation of the turn piece 126, for instance, in response to a signal from the keypad 106 or a signal received via the network interface device.

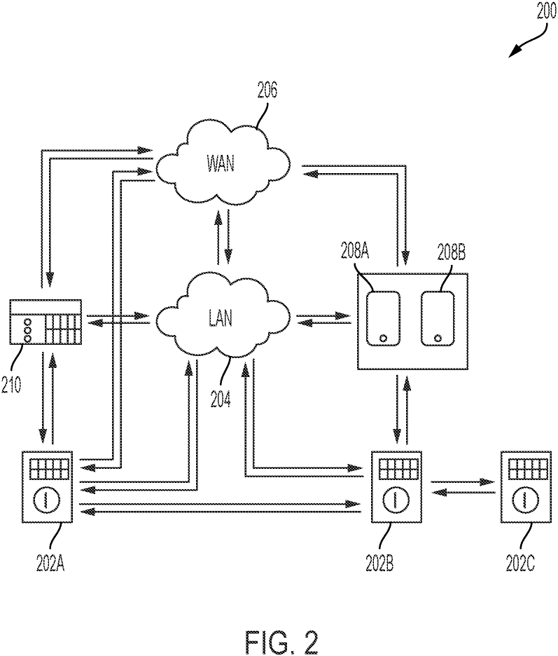

FIG. 2 is a diagram illustrating an exemplary network environment 200 in which the present systems and methods may operate according to various embodiments of the present disclosure. Network environment 200 may enable each of a plurality of electronic door locks 202A, 202B, and 202C to communicate with other devices, such as one or more personal computing devices 208A, 208B and an alarm system 210.

The electronic door locks 202A - 202C may, in certain embodiments, be connected to a LAN 204. LAN 204 may be, for instance, a WiFi network served by a home router and one or more access points. The LAN 204 may use any other suitable communication protocol (e.g., LoRa, Bluetooth, ethernet, etc.). Thus, the LAN 204 may include both or either of wired and wireless connections to devices. The LAN 204 may also connect to a WAN 206 (e.g., the internet, a cellular communications network, a LoRaWAN network, or any other suitable WAN). A WAN connection may enable a user to send signals via the Internet, for instance, to selectively change settings for the electronic door locks 202A-202C, and/or lock and unlock the electronic door locks 202A-202C.

The electronic door locks 202A-202C may utilize various combinations of connections within network environment 200. For example, a first electronic door lock 202A may connect to multiple devices using any of a variety of communication protocols. The first electronic door lock 202A may connect to the LAN 204 via a WiFi protocol, for example. The first electronic door lock 202A may also include a Global System for Mobile Communication (GSM) module to connect to the WAN 206 (e.g., by phone call, text, 4G, 5G, etc.). Redundant connections may enable the electronic door locks 202A - 202C to receive and send messages in the event of a local power outage, for instance by sending a text message if a home’s WiFi router is out of service. The first electronic door lock 202A may also connect to an alarm monitoring system 210 by a direct link (i.e., without passing through the LAN 204), for instance by a Bluetooth or other radio communication protocol. A direct connection between the alarm monitoring system 210 and the first electronic door lock 202A may enable a redundant connection to the WAN 206 through the alarm monitoring system 210. For example, the electronic door lock 202A may communicate with the alarm monitoring system 210 by a short-range, low power communication protocol, and the alarm monitoring system 210 may act as a gateway to the LAN 204 and/or the WAN 206 (e.g., by a GSM module providing a cellular phone connection, or by a wired connection via a phone or ethernet line). This may reduce the cost of the electronic door locks 202A - 202C, by requiring fewer communication modules for fewer communication protocols. It should be understood that the first and second electronic door locks 202B and 202C shown in FIG. 2 may be configured and function similarly to the first electronic door lock 202A described above.

FIG. 2 illustrates an additional network connection option for the second electronic door lock 202B. As shown in FIG. 2, the second electronic door lock 202B may connect to the LAN 204, for instance by a WiFi connection. In this manner, the LAN 204 may be a wireless local area network (WLAN). Further, the electronic door lock 202B may connect with the first electronic door lock 202A directly, or via the LAN 204, enabling lock-to-lock communication which may, in certain embodiments, lock or unlock multiple locks at a location when a first lock is unlocked or locked. Further, the electronic door lock 202B may connect directly to one or more personal computing devices 208 (e.g., phones, tablets, computers, etc.), for instance via a Bluetooth connection, and may use a direct connection to the personal computing devices 208 to enable setup of the electronic door locks 202A – 202C, or to enable automatic unlocking when a connection between the one or more personal computing devices 208 and one or more of the door locks 202A – 202C is detected. Further, the electronic door locks 202A – 202C may utilize one or more personal computing devices 208 as a communications bridge to the WAN 206 and/or the LAN 204. For example, the second electronic door lock 202B may use a Bluetooth connection to communicate with the first personal device 208A, and the first personal device 208A may forward a communication received from the Bluetooth communication to the WAN 206 (i.e., the Internet).

In some cases, an electronic door lock 202A – 202C may be installed out of range of a LAN 204 (i.e., beyond the range of a WiFi router). Thus, in certain embodiments, an electronic door lock (e.g., the third electronic door lock 202C) may communicate with an in-range electronic door lock (e.g., the second electronic door lock 202B). The second electronic door lock 202B may, in various embodiments, act as a range extender between the third electronic door lock 202C and the LAN 204, thereby providing connectivity between the third electronic door lock 202C and the LAN 204 and/or the WAN 206. For example, the third electronic door lock 202C may be adapted to pass communications between the second electronic door lock 202B and the LAN 204.

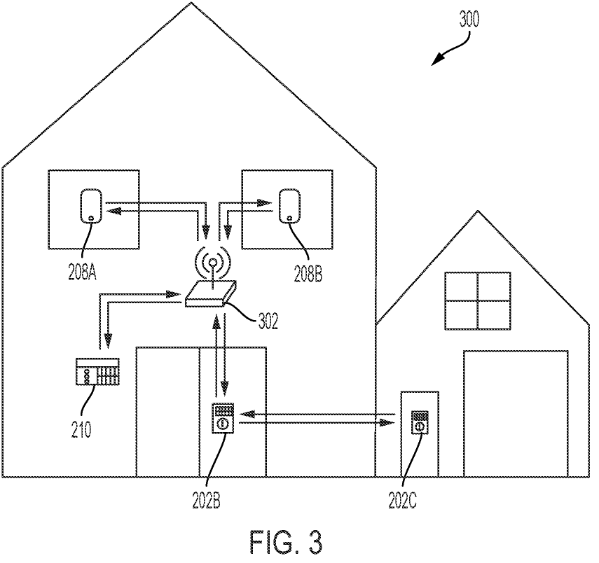

FIG. 3 is a diagram illustrating an exemplary physical environment in which the present systems and methods may operate according to various embodiments of the present disclosure. FIG. 3 provides a notional setup of elements of network environment 200 in the context of a home 300. For example, the home 300 may include a WiFi router 302. The WiFi router 302 may host a home network (i.e., LAN 204), and may also connect to the Internet (i.e., WAN 206). The WiFi router 302 may connect to one or more personal computing devices 208, and an alarm system 210.

FIG. 3 further illustrates example placements of second and third electronic door locks 202B, 202C on the house 300. For example, the second electronic door lock 202B in FIG. 3 is located on the front door of the house 300, and connects to the WiFi router 302. The third electronic door lock 202C is installed on a garage door. The third electronic door lock 202C is located further from the WiFi router 302 than the second electronic door lock 202B, and may thus be out of range of the WiFi router 302. As a result, the third electronic door lock 202C illustrated in FIG. 3 communicates with the second electronic door lock 202B, which is closer to the third electronic door lock 202C than the WiFi router 302. Thus, the third electronic door lock 202C may use the second electronic door lock 202B as a range extender or bridge to the WiFi router 302.

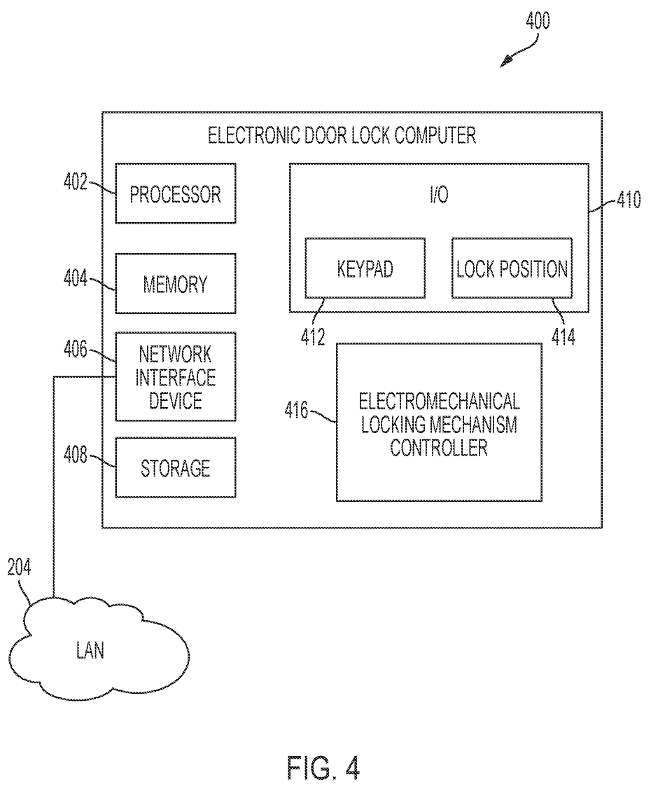

FIG. 4 is a schematic diagram of an electronic door lock computer 400 according to various embodiments of the present disclosure. Components of the electronic door lock computer 400 may optionally be housed on the circuit board 128 within the interior assembly 110, and may function as the computer hardware. Some components of the electronic door lock computer 400 may also be housed on a circuit board of the exterior assembly 102. The electronic door lock computer 400 may enable operation of the electromechanical locking mechanism, as well as performing networking operations (e.g., providing communication with the LAN 204).

In particular embodiments, the electronic door lock computer 400 may be connected to other computers in a LAN, an intranet, an extranet, and/or the Internet, such as other electronic door locks in a network, one or more personal computing devices 208, an alarm monitoring system 210, a WiFi router 302, etc. Further, while only a single computer is illustrated, the term “computer” shall also be taken to include any collection of computers that individually or jointly execute a set (or multiple sets) of instructions to perform any of the methods discussed herein.

The electronic door lock computer 400 may include one or more processors 402 and a main memory 404 (e.g., read-only memory (ROM), flash memory, dynamic random access memory (DRAM) such as synchronous DRAM (SDRAM) or Rambus DRAM (RDRAM), etc.).

The processor 402 may be one or more general-purpose processing devices such as a microprocessor, a central processing unit, or the like. In certain embodiments, the processor 402 may also be one or more special-purpose processing devices such as an application specific integrated circuit (ASIC), a field programmable gate array (FPGA), a digital signal processor (DSP), network processor, or the like. The processing device 402 may be configured to execute instructions stored in the memory 404 to perform operations and steps discussed herein.

The electronic door lock computer 400 may further include a network interface device 406, such as any or all of a WiFi module, GSM module, LoRa module, Bluetooth module, or any other suitable module. The network interface device 406 may connect to the LAN 204 or, in certain embodiments, the WAN 206 and/or individual devices (e.g., personal devices 208, alarm monitoring system 210, etc.).

The electronic door lock computer 400 may also include a storage 408. The storage 408 may include a non-transitory computer-accessible storage medium (also known as a non-transitory computer-readable storage medium or a non-transitory computer-readable medium) on which is stored one or more sets of instructions embodying any one or more of the methodologies or functions described herein. The software instructions may also reside, completely or at least partially, within the memory 404 and/or within the processing device 402. In certain embodiments, the software instructions may further be transmitted or received via the network interface device 406.

While the storage 408 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding and/or carrying a set of instructions for execution by the computer and that cause the computer to perform any one or more of the methodologies of the present embodiments. The term “computer-accessible storage medium” should accordingly be understood to include, but not be limited to, solid-state memories, optical and magnetic media, etc.

The electronic door lock computer 400 may also include an input/output (I/O) module 410. The I/O module 410 may include at least one sensor, and communicate sensor measurements to processor 402, for instance during locking and unlocking operations. For example, I/O module 410 may include a keypad sensor 412, which may interpret signals provided by a user at the keypad 106. The I/O module 410 may transform and transmit signals from the keypad sensor 412 to the processor 402. Additionally, the I/O module 410 may include a lock position sensor 414, such as a Hall effect sensor or conductivity sensor configured to detect when a deadbolt is extended or retracted, for example.

The electronic door lock computer 400 may also include an electromechanical locking mechanism controller 416. The electromechanical locking mechanism controller 416 may provide signals to the motor 120, for example. Further, the electromechanical locking mechanism controller 416 may translate a signal from the processor 402 in order to control the electromechanical locking mechanism, for instance by pulse width modulation or pulse timing.

As described previously, an electronic door lock according to various embodiments of the present disclosure may provide an option for a user to provide a “panic code” that causes the electronic door lock to send an emergency message on behalf of the user. This feature may be useful when a homeowner is forced to enter his house under duress, such as during a robbery for instance.

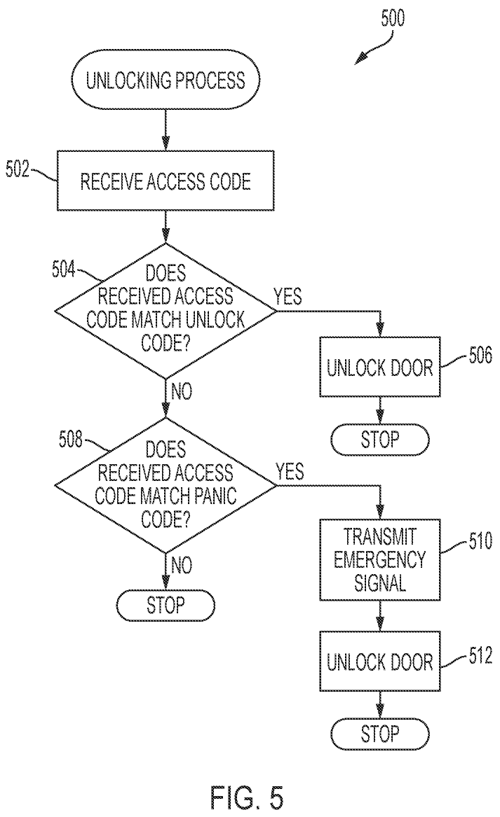

FIG. 5 is a flowchart showing an example unlocking process 500 for unlocking an electronic lock according to various embodiments of the present disclosure. The unlocking process 500 may be performed by the computer hardware of the electronic door lock (e.g., electronic lock computer 400). In certain embodiments, a computer-readable medium may store computer-executable instructions for performing steps of the unlocking process 500.

The unlocking process 500 begins with receiving an access code at step 502. The access code may be provided at the keypad 106, and may include (e.g., be) a sequence of numbers, letters and/or symbols. Further, the access code may be submitted upon pressing an “unlock” button. The I/O module 410 of the electronic lock computer 400 may transmit signals provided by the keypad 106 to the processor 402, and, in some embodiments, may also process the signals prior to transmitting. Alternatively, the access code may be entered via an app interface on a user’s personal computing device, and transmitted over the LAN 204 and/or the WAN 206 to the network interface device 406. The network interface device 406 may transmit the received signal to the processor 402, and may also process the received signal prior to transmitting.

At step 504, the unlocking process 500 analyzes the access code to determine whether the access code is a first particular code. The first particular code may be an unlock code used for everyday entry into a home or other location, and may be, for instance, a key sequence provided by a user through an app on a personal device (e.g., personal device 208A) or by a particular key sequence stored in the electronic door lock (e.g., in a memory 404 and/or a storage 408) for use in the unlocking process 500. In certain embodiments, unlocking process 500 may compare the received access code with multiple entry codes, such as for locations with multiple residents or workers having personalized entry codes. If the access code matches an unlock code (e.g., is a first particular code), the determination of step 504 is YES, and the unlocking process 500 may proceed to step 506 to unlock a door associated with the electronic door lock. For example, the electronic door lock’s electromechanical locking mechanism may disengage a lock component configured to prevent a door from opening (e.g., cause a deadbolt to retract, cause a locking pin in a door knob to disengage and free the door knob to rotate, etc.).

However, if the access code does not match the first particular code, the determination of step 504 is NO, and the unlocking process 500 proceeds to step 508 to determine whether the access code is a second particular code. The second particular code may be, for example, a panic code. The second particular code may be, for example, a sequence of numbers, letters, and/or symbols that are different from the first particular code The second particular code may be, for instance, a key sequence provided by a user through an app on a personal computing device (e.g., personal computing device 208) or by a particular key sequence programmed using the keypad 106 and stored in the electronic door lock (e.g., in memory 404 and/or storage 408) for later comparison during the unlocking process 500. In some embodiments, the second particular code may be a combination of button presses not including number, for instance, “lock-unlock-lock”. In certain embodiments, the second particular code may be a sequence of key presses that is appended to (e.g., precedes or follows) an unlock code. For example, the second particular code may be the sequence “1-2-3”, and the first particular code may be the sequence “4-5-6”. Thus, if a user enters “4-5-6”, the electronic lock computer 400 may cause the electromechanical locking mechanism to disengage a lock component. However, if the user enters “1-2-3-4-5-6” or “4-5-6-1-2-3”, the electronic lock computer 400 may detect that the second particular code at least partially matches the entered code. In this way, a user under duress may more easily trigger the second particular code, as the user may be unable to remember a separate code due to stress or panic.

If the access code does not match the second particular code, the determination at step 508 is NO, and the unlocking process 500 stops. If the received access code matches the second particular code, the determination at step 508 is YES, and the unlocking process 500 proceeds to step 510 to initiate a transmission of an emergency signal via the one or more networking components (i.e., network interface device 406). For example, the electronic lock computer 400 may transmit (or otherwise initiate the transmission of – e.g., via a separate computer) a text message, email, phone call, email, and/or app notification at step 510. The electronic lock computer 400 may also or alternatively transmit an emergency signal to the alarm management system 210. In certain embodiments, the electronic lock computer 400 may transmit an emergency signal to other electronic door locks at a house. Upon receipt of the emergency signal, the other electronic door locks may perform an action, such as unlocking, so that all of the doors at a house are unlocked to enable police to enter and/or the user to flee.

Further, the emergency signal may be transmitted to one or more emergency services agencies (e.g., the police, an alarm monitoring company, etc.), and may be transmitted through the network environment 300. For instance, the emergency signal may be initiated by a transmission from an electronic door lock 202, through the LAN 204, to the WAN 206, in order to reach a destination (e.g., one or more computing devices associated with the police, an alarm monitoring company, one or more family members of the individual entering the code, one or more friends, etc.). Different components of the network environment 300 may add information to the transmission. For example, the electronic door lock may send a lock identifier and emergency indication to an alarm monitoring system (e.g., alarm monitoring system 210). The alarm monitoring system 210 may use this information to generate an electronic emergency alert including an indication that there is an emergency at a particular location (e.g., a particular door at a particular residence). The electronic emergency alert may also include an alert destination (e.g., a phone number or email address of a designated individual). The alarm monitoring system 210 may then transmit the message via the LAN 204 to the WAN 206 (or directly to the WAN 206) for transfer to a destination. Alternatively, an electronic door lock may generate the electronic emergency alert and transmit the alert to the designated individual directly via the LAN 204 and/or the WAN 206. It should also be understood that the system may generate and transmit the alert via any other suitable computing device or mechanism.

In certain embodiments, the unlocking process 500 may optionally proceed to step 512 to unlock the door by causing the electromechanical locking mechanism to disengage the lock component configured to prevent the door from opening. This may allow the user to trigger an emergency signal without alerting an attacker since the door will open in response to the user entering the panic code, just as it would open in response to the user entering a normal access code.

In certain embodiments, a user may be able to set lock preferences, such as lock preferences for responding to entry of a panic code. For example, a user using a personal computing device (e.g., personal computing device 202A or 202B) may interact with an app to select preferences for lock behavior and other settings. The app may transmit the user preferences to an electronic door lock (e.g., electronic door lock 202A, 202B, 202C), for instance using a wireless connection (e.g., Bluetooth, WiFi, etc.). A user may select preferences during a setup phase of an electronic door lock, and may be able to change settings in the app as well.

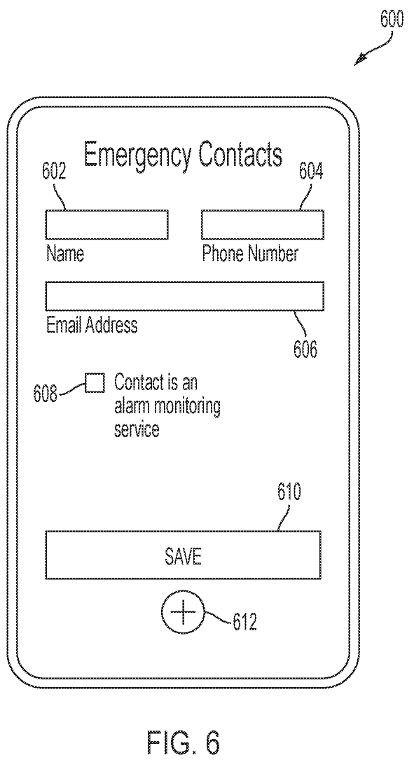

A user may establish preferences for a recipient of an emergency signal via an app. For example, FIG. 6 provides an exemplary user interface allowing a user to input an emergency contact. The app may be provided on a personal device and transmit data to an electronic door lock (e.g., via Bluetooth), an alarm monitoring system (e.g., via the LAN 204), and/or an alarm monitoring service (e.g., via the WAN 206). As shown in FIG. 6, the app may provide an interface with multiple input fields 602-608. Field 602 may allow a user to input an emergency contact’s name. Fields 604 and 606 allow a user to input an emergency contact’s phone number and email address. Field 608 allows a user to indicate that the contact provided is an alarm monitoring service. Button 610 allows the user to save and transmit the emergency contact information to the electronic door lock, for example. Button 612 allows a user to enter additional emergency contacts, which the system may, for example, also notify (e.g., simultaneously notify) if a panic code is entered into the electronic door lock. In this way, the electronic door lock may be configured to transmit an emergency signal to a designated individual, or to a plurality of designated individuals.

Thus, in some cases, the electronic door lock may facilitate transmission of an alert to a designated individual (i.e., emergency contact) who is remote from a particular residence where the electronic door lock is installed, or a plurality of designated individuals. This may be accomplished by, for instance, directly or indirectly facilitating transmission of the alert to a WAN (e.g., a cellular network, or the internet) so that the alert may be transmitted to a different location where a designated individual may be (e.g., to a computing device at the designated individual’s home). Alternatively or additionally, the alert may be transmitted to a local designated individual, such as a designated individual within range of a LAN (e.g., a WiFi network) to which the electronic door lock is connected. For example, the alert may be transmitted to a computing device associated with an individual who is within a house to which the electronic door lock is attached.

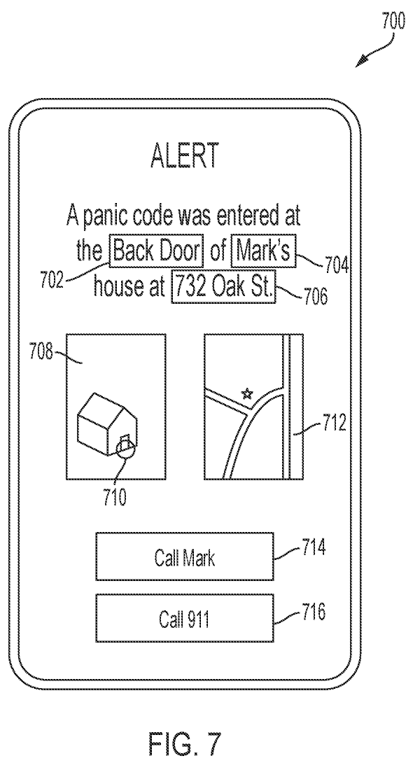

FIG. 7 illustrates an exemplary alert display 700 as described herein (e.g., an emergency signal or an electronic emergency alert). The alert display 700 may be displayed, for example, on a personal computing device (or other computing device) of an individual designated as an emergency contact by a user within the exemplary user interface of FIG. 6. A user device of a designated individual may show the alert display 700 after receiving an emergency signal that an electronic door lock initiated in response to receiving a panic code. The alert display 700 may include multiple pieces of information enabling an emergency contact to help an individual (e.g., a homeowner) in distress, including an indication that the individual needs assistance. In certain cases, the alert display may include information about the individual’s current location (e.g., a business, apartment complex, or other location where the electronic door lock is installed).

As shown in FIG. 7, the alert display 700 may inform a recipient of a location on a particular structure, such as a particular office building or dwelling, of the door lock on which a panic code was entered. For instance, the alert display 700 may indicate that the electronic door lock at the only back door of a particular residence received a panic code in a location field 702. The alert display may also indicate the name of the person who has designated the recipient as an emergency contact (e.g., “Mark” as shown in a field 704). The alert display may provide additional location information, such as the address of the structure (e.g., office building or dwelling) to which the electronic door lock is attached (e.g., “732 Oak St.” as in field 706). In certain embodiments, the alert display 700 may include an image 708 of the structure where electronic door lock is installed, as well as a visual indication 710 of where the electronic door lock is installed on the structure. A user may, for instance, provide a picture of the door when installing the electronic door lock via an app. In certain embodiments, the electronic door lock may also include a GPS module, and the alert display may include GPS coordinates provided by the GPS module (e.g., numbers, and/or a map illustrating the coordinates). Further, the alert display 700 may include a map 712 of the house location.

The alert display 700 may include a call button 714 which, when selected, causes the emergency contact’s personal device to call the user who provided the recipient as an emergency contact. Further, the alert display 700 may include an emergency call button 716 that, when selected, may automatically dial a phone number for emergency services (e.g., to initiate a call to 911).

In certain embodiments, the alert display 700 may be provided to a recipient device within an app on the recipient device. For instance, the recipient device may show a notification from an app that, when selected, causes the recipient device to display the alert display 700. However, in some cases, an emergency contact’s personal device may not have the app installed. Thus, the electronic emergency alert may include a text message, or other suitable electronic message such as an email, including information of the alert display 700 in text form, and/or may include having a link to a website displaying the alert display 700.

In certain cases, an electronic door lock according to various embodiments of the present disclosure may provide the emergency alert functionality discussed above by using a WLAN. However, some WLAN protocols may require substantially continuous (e.g., continuous) connectivity that drains battery life. For example, an electronic door lock connected to a WiFi network may consume battery power by maintaining connection to the WiFi network. However, depleted batteries may prevent normal electronic functioning of the electronic door lock (e.g., prevent the electronic door lock from electronically unlocking a door), or may prevent the electronic door lock from initiating an electronic emergency alert during an emergency.

To avoid this, a user may desire to turn off connectivity of an electronic door lock during periods when connectivity is not needed, for instance, while a homeowner is traveling or while a business is closed. Accordingly, in some embodiments, the electronic door lock is configured to allow a user to selectively toggle connectivity configurations. For example, in various embodiments, the electronic door lock is configured to allow a user to selectively toggle (or otherwise switch) the electronic door lock between a first configuration in which the electronic door lock is connected to a local communication network (e.g., a WiFi network), and a second configuration in which the electronic door lock is not connected to a local communications network (e.g., the electronic door lock is not connected to any communications network).

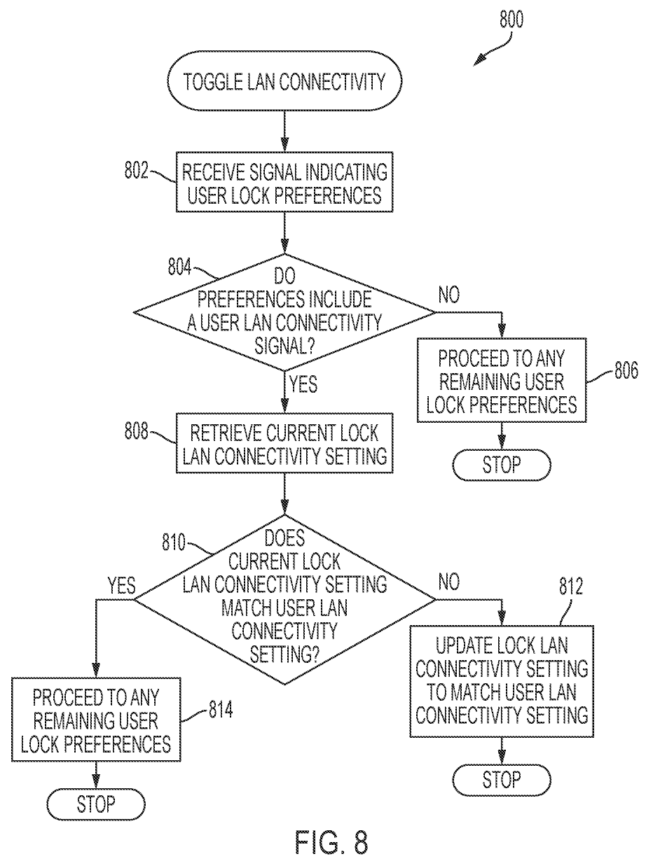

FIG. 8 illustrates LAN connectivity toggle process 800. The LAN connectivity toggle process 800 may be performed by the computer hardware of the electronic door lock (e.g., electronic lock computer 400). In certain embodiments, a computer-readable medium may store computer-executable instructions for performing steps of the LAN connectivity toggle process 800. A similar process to the LAN connectivity toggle process 800 may be used to set WAN connectivity preferences.

The LAN connectivity toggle process 800 begins with step 802 by receiving a signal indicating at least one user lock preference. The signal may be received, for example, from a personal computing device via first LAN (e.g., Bluetooth connection) and provide preferences about a second LAN (e.g., a WiFi network), for instance. The personal computing device may utilize an app to collect and transmit the user’s electronic lock preferences to the electronic door lock. Alternatively or additionally, the electronic door lock may be configured to allow the user to selectively toggle the electronic door lock between the first configuration and the second configuration via a user interface on the electronic door lock. For example, the electronic door lock may receive the signal indicating user lock preferences from a tactile button, for instance disposed on a housing of the electronic door lock. In certain embodiments, the signal indicating user lock preferences may be received from the keypad 106, and may include a certain sequence of key presses, for instance.

At step 804, the LAN connectivity toggle process 800 may determine if the user lock preferences include a user LAN connectivity setting. If the signal does not include a user LAN connectivity setting (e.g., if the signal is received from a personal device via an app collecting multiple user lock preferences), the determination at step 804 is NO, and the LAN connectivity toggle process 800 proceeds to step 806 to implement any remaining user lock preferences (e.g., access codes, panic codes, WAN connectivity toggle, etc.). However, if the determination at step 804 is YES, the LAN connectivity toggle process 800 proceeds to retrieve a current lock LAN connectivity setting at step 808.

The LAN connectivity toggle process 800 then proceeds to determine if the current lock LAN connectivity setting matches the user LAN connectivity setting at step 810. If the current lock LAN connectivity setting does not match the user LAN connectivity setting, the determination at step 810 is NO, and the LAN connectivity toggle process 800 proceeds to step 812 to update the LAN connectivity setting to match the user LAN connectivity setting. Otherwise, if the determination at step 810 is YES, the LAN connectivity toggle process 800 proceeds to step 814 to process any remaining user lock preferences. In this way, a user may set an electronic door lock LAN connectivity setting as either on or off in order to conserve battery power as desired.

It is noted that the term toggle, as used in the description above, refers to any suitable method for switching between two different network connectivity settings (e.g., between “WiFi on” and “WiFi off” settings). It should be understood that the electronic door lock settings may be configured to allow a user to toggle between more than two different settings, and that toggling may be done in any suitable way, such as by selecting suitable radio buttons, checkboxes, or by making settings via a suitable natural language interface such as a suitable app on digital voice personal assistant such as an Alexa enabled speaker.

### CONCLUSION

Many modifications and other embodiments of the disclosure will come to mind to one skilled in the art to which this disclosure pertains having the benefit of the teachings presented in the foregoing descriptions and the associated drawings. For example, as will be understood by one skilled in the relevant field in light of this disclosure, the embodiments may take form in a variety of different mechanical and operational configurations. As a particular example, although various embodiments describe an electronic door lock for use on standard house or office building doors, alternative embodiments may be embodied in the form of other locks, such as gate locks, locks for garage doors, or other types of locks. Therefore, it is to be understood that the disclosure is not to be limited to the specific embodiments disclosed herein, and that the modifications and other embodiments are intended to be included within the scope of the appended exemplary concepts. Although specific terms are employed herein, they are used in a generic and descriptive sense only and not for the purposes of limitation.

We claim:

1. An electronic door lock comprising:
an electromechanical locking mechanism;
computer hardware that is configured for selectively moving the electromechanical locking mechanism between a locked configuration and an unlocked configuration; and
one or more networking components that are configured for facilitating communication between the computer hardware and one or more computer networks that are external to the electronic door lock, wherein the electronic door lock is configured for:
receiving an access code from a user;
analyzing the access code to determine whether the access code is a first particular code or a second particular code;
in response to determining that the access code is the first particular code, causing the electromechanical locking mechanism to disengage a lock component configured to prevent a door from opening; and
in response to determining that the access code is the second particular code, initiating a transmission of an emergency signal via the one or more networking components.

2. The electronic door lock of claim 1, wherein the emergency signal comprises an indication that the user needs assistance.

3. The electronic door lock of claim 1, wherein the emergency signal comprises an indication of the location of the door lock.

4. The electronic door lock of claim 3, wherein the location of the door lock comprises an indication of which door on a particular dwelling the lock is located on.

5. The electronic door lock of claim 1, wherein the second particular code is a panic code.

6. The electronic door lock of claim 1, wherein the electronic door lock is further configured for, in response to determining that the access code is the second particular code, causing the electromechanical locking mechanism to disengage the lock component configured to prevent the door from opening.

7. The electronic door lock of claim 6, wherein the emergency signal comprises an indication that the user needs assistance.

8. The electronic door lock of claim 7, wherein the emergency signal comprises an indication of the location of the door lock.

9. The electronic door lock of claim 8, wherein the location of the door lock comprises an indication of which door on a particular dwelling the lock is located on.

10. The electronic door lock of claim 9, wherein the electronic door lock is configured for facilitating transmission of the emergency signal directly to at least one designated individual.

11. The electronic door lock of claim 9, wherein the electronic door lock is configured for facilitating transmission of the emergency signal directly to a plurality of designated individuals.

12. The electronic door lock of claim 1, wherein the electronic door lock is configured to allow a user to selectively toggle the door lock between:
(A) a first configuration, in which the electronic door lock is connected to a local communications network; and
(B) a second configuration, in which the electronic door lock is not connected to local communications network.

13. The electronic door lock of claim 12, wherein the local communications network is a wireless local area network.

14. The electronic door lock of claim 12, wherein the electronic door lock is configured to allow the user to selectively toggle the electronic door lock between the first configuration and the second configuration via a user interface on the electronic door lock.

15. The electronic door lock of claim 12, wherein the electronic door lock is configured to allow the user to selectively toggle the electronic door lock between the first configuration and the second configuration via an application associated with a personal computing device associated with the user.

16. A method of generating an electronic emergency alert, the method comprising:
receiving a panic code at a door lock that is on a particular door at a particular residence;
in response to receiving the panic code, automatically generating an electronic emergency alert comprising:
(A) an indication that that there is an emergency at a particular location; and
(B) an indication that the particular location is the particular door at the particular residence; and
facilitating the transmission of the alert to at least one designated individual.

17. The method of claim 16, wherein facilitating the transmission of the alert to at least one designated individual comprises facilitating the electronic transmission of the alert to at least one designated individual who is remote from the particular residence.

18. The method of claim 16, wherein facilitating the transmission of the alert to at least one designated individual comprises facilitating the electronic transmission of the alert to a plurality of designated individuals who are remote from the particular residence.

19. The method of claim 12, wherein the method further includes, in response to receiving the panic code, unlocking the particular door.

20. An electronic door lock comprising:
an electromechanical locking mechanism;
computer hardware that is configured for selectively moving the electromechanical locking mechanism between a locked configuration and an unlocked configuration; and
one or more networking components that are configured for facilitating communication between the computer hardware and one or more computer networks that are external to the electronic door lock, wherein the electronic door lock is configured to allow a user to selectively toggle the door lock between:
(A) a first configuration, in which the electronic door lock is connected to a local communications network; and
(B) a second configuration, in which the electronic door lock is not connected to local communications network.

21. The electronic door lock of claim 21, wherein the local communications network is a wireless local area network.

22. The electronic door lock of claim 21, wherein the electronic door lock is configured to allow the user to selectively toggle the electronic door lock between the first configuration and the second configuration via a user interface on the door lock.

23. The electronic door lock of claim 21, wherein the electronic door lock is configured to allow the user to selectively toggle the electronic door lock between the first configuration and the second configuration via an application associated with a personal computing device associated with the user.

24. A computer-readable medium storing computer-executable instructions for:
receiving an access code from a user;
analyzing the access code to determine whether the access code is a first particular code or a second particular code;
in response to determining that the access code is the first particular code, causing an electromechanical locking mechanism to disengage a lock component configured to prevent a door from opening; and
in response to determining that the access code is the second particular code, initiating a transmission of an emergency signal via one or more networking components.

25. The computer-readable medium of claim 24, wherein the emergency signal comprises an indication of the location of the door lock.

26. The computer-readable medium of claim 24, wherein the instructions further include allowing a user to selectively toggle the door lock between:
(A) a first configuration, in which an electronic door lock is connected to a local communications network; and
(B) a second configuration, in which the electronic door lock is not connected to local communications network.
